(19) United States
(12) Patent Application Publication
(10) Pub. No.: US 2026/0340489 A1
(43) Pub. Date: Oct. 29, 2026

(54) Method and Apparatus for Improving Quality of Labeled Dataset Used for Detecting Fileless Cybersecurity Attacks

(71) Applicant: Crowdstrike, Inc., Sunnyvale, CA (US)

(72) Inventors: Olga Ewa GDULA, Reading (GB); Felix SCHWYZER, Berlin (DE); Damian MONEA, Bucharest (RO)

(21) Appl. No.: 19/190,348

(22) Filed: Apr. 25, 2025

(51) Int. Cl. G06N 20/00; G06F 40/56; H04L 9/40

(52) U.S. Cl. CPC G06N 20/00; G06F 40/56; H04L 63/1416

(57) ABSTRACT

A computer-implemented method selects from a first dataset accessible in a first cloud computing environment labeled entities written in a first language, translates the labeled entities into a second language, and generates aggregated statistical information for the translated labeled entities. The method further generates aggregated statistical information for unlabeled entities obtained from a second dataset accessible only in a second cloud computing environment and written in the second language, selects some of the translated labeled entities, based on the aggregated statistical information for the translated labeled entities and the aggregated statistical information for the unlabeled entities, and adds the selected translated labeled entities to the first dataset thereby creating an expanded first dataset. A Machine Learning (ML) model is trained with the expanded first dataset, then deployed in the second cloud computing environment to detect behaviors in entities in events received from client computing devices operating therein.

### COPYRIGHT NOTICE

A portion of this disclosure contains material which is subject to copyright protection. The copyright owner has no objection to the facsimile reproduction by anyone of the disclosure as it appears in the Patent and Trademark Office patent file or records, but otherwise reserves all copyright rights whatsoever.

### TECHNICAL FIELD

Embodiments relate to improving the quality or robustness of a labeled dataset used for training a machine learning model that detects cybersecurity attacks.

### BACKGROUND

Given the rise in fileless cybersecurity attacks, such as “living off the land” attacks that use existing, legitimate, tools on a computing device, and hands-on-keyboard activity, cybersecurity experts are actively developing new Machine Learning (ML) approaches for detecting and mitigating fileless attacks, including approaches based on applying Machine Learning approaches to entities such as command lines and/or process trees.

To that end, labeled data can be used either directly in training new ML models, or to improve existing ML models.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a flowchart of aspects of a computer-implemented method according to an embodiment of the invention.

FIG. 2 is a flowchart of aspects of a computer-implemented method according to an embodiment of the invention.

FIG. 3 is a flowchart of aspects of a computer-implemented method according to an embodiment of the invention.

FIG. 4 illustrates an example architecture for a computing device capable of carrying out an embodiment of the invention.

### DETAILED DESCRIPTION

The goal of the disclosed embodiments is to improve the performance of a cybersecurity service provider’s cybersecurity attack detection services for customers whose client computing devices reside outside a first language region, or first language convention region, for example, the United States.

Cybersecurity service providers are expanding behavioral classifiers, that operate on entities. Entities include, for example, command lines, file path names, process trees, and character strings, tokens, or comments written in source code, scripts, or macros. These entities may be used in conducting so-called fileless attacks on client computing devices, rather than using files on disk to conduct such attacks.

Cybersecurity service providers receive entities in events transmitted from sensors residing on client computing devices. Detecting malicious activity in the entities frequently involves algorithmically processing string fields such as command lines or file path names. In practice, most of such fields used in training datasets to train detection algorithm(s) originate from computing devices operating in the English language since they are based on data obtained from client devices located in the United States. However, this can lead to a loss of precision in the detection algorithm(s) when they parse strings from client computing devices that operate in languages other than English, such as devices located and operating in a foreign cloud computing environment, for example, located in Europe or Asia.

For example, a machine learning algorithm may learn embeddings for a string of characters such as "C:\\Program Files", which is present in the training data, but not for "C:\\Programme", which it may encounter when running predictions on a German-language machine, which, in turn, may lead to different performance results for the classifier on the German machine, including a risk of false positives and/or false negatives. Similarly, sub-word-level tokens or character strings (e.g., 1-, 2-, or 3-character-long strings), that are used in ML model training occur at a different frequency or rate in command lines or file paths from devices operating in English than they do in other languages. There is also a further risk that characters the model has not seen in training with English language/US data (e.g., non-Latin-based alphabets, or special characters such as umlauts) can result in detection services making inaccurate decisions. Being able to spot, and address, such potential issues prior to deployment of detection services can improve quality control.

While it may seem that this problem could, in theory, be overcome by collecting event data from other countries (such as countries in the European Union (EU)) and adding those events to a training dataset in the United States, there are two limitations to this approach. Firstly, data export laws such as the EU General Data Protection Regulation (GDPR) can prevent cross-border movement of data, such as data exported outside of the EU. Secondly, collecting a multi-language set of labeled entities would require a significant cost in terms of threat analyst hours to hunt for multi-language equivalences of existing entities based on data from other countries. Analysts’ time could instead be better spent on reviewing new entities, or monitoring and improving existing models.

To address these issues, the disclosed embodiments present a framework for multi-language model monitoring and training, in which new, multi-language entities are created from existing English-language entities, using a Large Language Model, in a manner which preserves the key statistical characteristics of the restricted target dataset (e.g., EU data which cannot be exported for ML model training on a combined dataset), for the purposes of passing the synthetic data to a Machine Learning detection model, to uncover any issues with inaccurate predictions, such as false positives or false negatives, and to use the synthetic data for model improvement via model retraining. Thus, the disclosed embodiments provide a framework that uses machine learning to extract elements from sensor events/entities (e.g., command lines) for translation to generate synthetic data for model testing and training, in a way which maintains the general characteristics of target multi-language data, and that is compliant with or mindful of data export legislation.

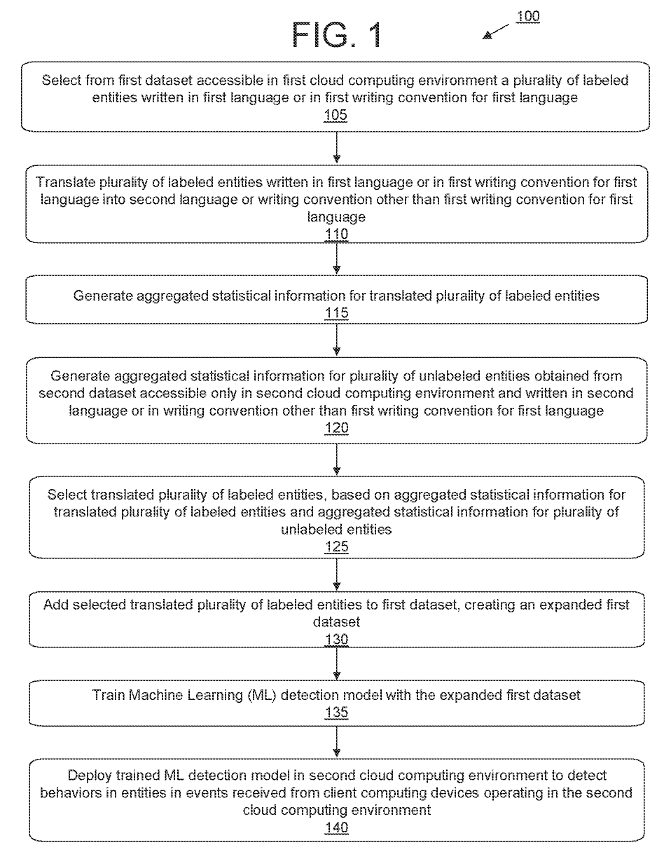

With reference to FIG. 1, the disclosed embodiments involve a computer-implemented method 100, performed by a computing device having at least a memory in which to store executable instructions and a processing unit to read and execute the instructions according to the computer-implemented method. The method includes executing logic at block 105 to select from a first dataset accessible in a first cloud computing environment a plurality of labeled entities, or elements thereof, written in a first language or in a first writing convention for the first language. For example, the first dataset may be in a cloud computing environment in the United States and may be an English language-based dataset, as opposed to, say, a German language-based dataset in which the entries originate from devices operating in a German language.

According to one embodiment, user input (e.g., a threat analyst’s or data scientist’s input) may be received to select the plurality of labeled entities, or elements thereof. Labeled entities, or elements thereof, may be character strings, command lines, file path names, comments in computer code, scripts, macros, words, or sub-word-level tokens or character strings.

Alternatively, according to one embodiment, selecting from the first dataset accessible in the first cloud computing environment the plurality of labeled entities, or elements thereof, written in the first language or in the first writing convention for the first language, involves selecting from the first dataset via a Large Language Model (LLM) or syntax-tree generation algorithm the plurality of labeled entities, or elements thereof, written in the first language. One basis for doing so is giving consideration to what strings should be modified, such as “C:\\Program Files” should be modified to “C:\\Programme Files”, but “C:\\Windows\\System32” should not be modified to “C:\\Fenster\System32”.

Logic block 110 translates the plurality of labeled entities, or elements thereof, written in the first language or in the first writing convention for the first language into a second language or a writing convention other than the first writing convention for the first language. For example, the plurality of labeled entities written in the English language or in a North American writing convention for the English language may be translated into a second language (e.g., German) or a British writing convention which is different than the North American writing convention for the English language.

According to one embodiment, logic block 110 translating the plurality of labeled entities written in the first language or in the first writing convention for the first language into the second language or the writing convention other than the first writing convention for the first language, involves modifying one or more of the plurality of labeled entities, or elements thereof, written in the first language or in the first writing convention for the first language to include characters with which the plurality of labeled entities can be written in the second language or in the writing convention other than the first writing convention for the first language.

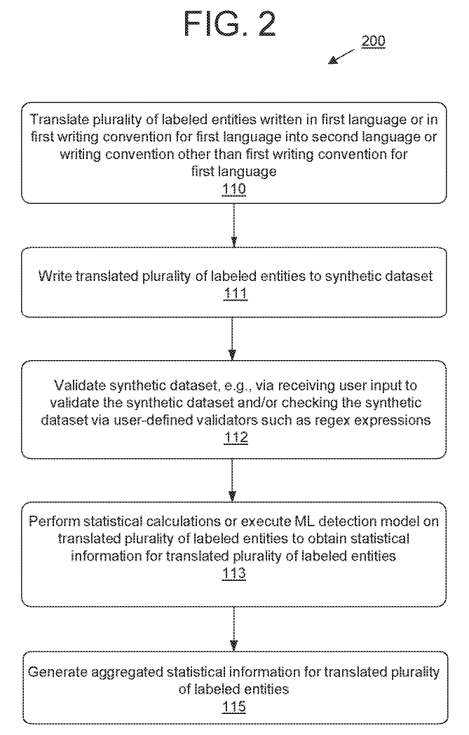

With reference to FIG. 2, according to one embodiment 200, after or as the translation of the plurality of labeled entities is performed, the translated labeled entities may be written at logic block 111 to a synthetic dataset. “Synthetic data” or a synthetic dataset is data that is artificially generated rather than produced by real-world events and is typically created by algorithms.

According to one embodiment, user input can be received at logic block 112 to validate the synthetic dataset. Alternatively, the synthetic dataset can be checked or verified via or compared to user-defined validators such as regex expressions.

Logic block 113 then performs statistical calculations or executes a machine learning (ML) model on the translated plurality of labeled entities to obtain statistical information for each of the translated plurality of labeled entities. The statistical information may include, for example, a rate of occurrence of a translated entity, a degree of importance of a translated entity, and/or a Shapley value (derived from the ML model) for a translated entity. A Shapley value is a measure of the relative impact of different features derived from an entity, on the eventual output of the machine learning model by comparing the relative effect of the inputs against the average.

Next, logic block 115 generates aggregated statistical information for the translated plurality of labeled entities. This aggregated statistical information is high-level statistical information which is acquired by combining the individual entity data. According to one embodiment, logic block 115 generating the aggregated statistical information for the translated plurality of labeled entities involves generating, via statistical calculations or execution of a Machine Learning (ML) model, statistical information for each of the translated plurality of labeled entities, and then aggregating the statistical information for each of the translated plurality of labeled entities to produce the aggregated statistical information for the translated plurality of labeled entities.

The disclosed embodiments now shift, at logic block 120, to generating aggregated statistical information for a plurality of unlabeled entities obtained from a second dataset accessible only in the second cloud computing environment and written in the second language or in the writing convention other than the first writing convention for the first language. For example, aggregated statistical information is gathered on real-world data in a target region, such as real-world data in a cloud computing environment located in the European Union (EU). The logic block 120 operates on data in the target or foreign cloud computing environment, without the need for the data to be moved or migrated or exported from the target or foreign cloud computing environment.

Like the statistics generated by logic block 111 for the synthetic data, logic block 120 calculates or generates statistics on the real-word data in the target or foreign cloud computing environment based on an ML model, such as feature importance scores or Shapley values (numerical values which indicate how much, and in which direction, a feature influences a prediction score). The model predictions are performed on real-world data held in the target or foreign cloud computing environment, without any such data being moved from that cloud to any other cloud computing environment.

According to one embodiment, the predictions and/or feature importance/Shapley value scores calculated by logic block 120 are aggregated across groups of devices, to produce aggregate statistics for the target cloud computing environment or for each group. For example, the aggregation can consist of calculating what percentage of decision values fall in different brackets e.g., between 0 and 0.05, then between 0.05 and 0.10, and so on. Alternatively, the aggregation may involve calculating the average of the absolute values of Shapley values associated with each of the features in the ML model, where the average can be calculated across the entire cloud (e.g., the EU cloud), or across groups of events where the group assignments do not contain personal identifiable information (PII). So, for example, a group could consist of all events originating from Germany, or all events relating to a system binary such as svchost.exe. The aim of these statistics is to obtain statistical information relevant to the ML model, in a way such that no PII is contained in the aggregated statistics.

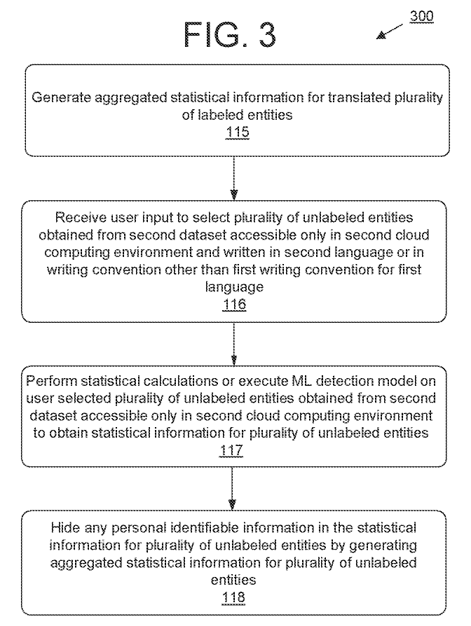

With reference to FIG. 3, according to an embodiment 300, the execution of logic block 120 may be preceded by execution of logic blocks 116 and 117, which handle receiving user input to select the plurality of unlabeled entities written in the second language or according to the different writing convention and accessible only in a target cloud computing environment, and executing the ML model on the plurality of unlabeled entities accessible only in the target cloud computing environment to obtain the statistical information for each of the plurality of unlabeled entities accessible only in the target cloud computing environment. Then logic block 118 can hide any personal identifiable information (PII) in the statistical information for the selected plurality of unlabeled entities by generating aggregated statistical information for the plurality of unlabeled entities obtained from the second dataset accessible only in the second cloud computing environment and written in the second language or in the writing convention other than the first writing convention for the first language.

At this point, according to one embodiment, a data scientist or threat analyst may analyze model predictions and feature importance data from the statistics calculated on the synthetic dataset by logic block 111 to understand the robustness of the ML model to non-English inputs and/or special characters. This analysis can inform further action such as future model retrains, feature extraction engine redesign etc.

Logic block 125 selects one or more (i.e., a subset) of the translated plurality of labeled entities from the synthetic dataset, based on the aggregated statistical information for the translated plurality of labeled entities, with the aim of selecting those labeled entities that, when aggregated, produced similar aggregation statistics at logic block 115 compared to the aggregation statistics obtained on the real word data by logic block 120. In other words, logic block 125 selects one or more of the translated plurality of labeled entities, based on the aggregated statistical information for the translated plurality of labeled entities and the aggregated statistical information for the plurality of unlabeled entities. According to one embodiment, logic block 125 does this by selecting one or more of the translated plurality of labeled entities for which the aggregated statistical information is substantially similar to the aggregated statistical information for the selected plurality of unlabeled entities. Substantially similar may be defined by an application or a consumer of the statistical information. For example, an application or consumer of the statistical information may select whatever threshold is desired in terms of the degree of similarity of the aggregated statistical information for the translated plurality of labeled entities and the aggregated statistical information for the plurality of unlabeled entities. This threshold may be a measure of the overlap in probability distributions for the aggregated statistical information for the translated plurality of labeled entities and the aggregated statistical information for the plurality of unlabeled entities.

Next, the selected one or more of the translated plurality of labeled entities are added at logic block 130 to the first dataset, thereby expanding and improving the quality of the data in the first dataset, in particular, when used to predict malicious events on client computing devices in foreign or target cloud computing environments outside a US-based cloud computing environment. At step 135, this expanded dataset is used to train a ML detection model to detect behaviors (e.g., malicious activity) in entities included in the events received from client computing devices. Finally, at step 140, the ML detection model, once trained, is deployed for use in detecting the behaviors in the entities included in the events received from client computing devices. According to an embodiment, the ML model, once trained with the expanded first dataset, may be deployed in the first cloud computing environment, and/or the second cloud computing environment, to detect behaviors in the entities included in the events received from client computing devices respectively operating in the first and/or the second cloud computing environments.

Thus, a novel aspect of the disclosed embodiments lies in leveraging a Large Language Model (LLM) to modify selected parts of existing entities (e.g. command lines/process trees) into versions which would appear on computers in different spoken languages and/or which contain characters which are uncommon on English-language machines used by English-language users. Additionally, the disclosed embodiments go beyond simple AI/ML-aided translation. Firstly, the disclosed embodiments leverage an algorithm (either a syntax tree building algorithm, or a Large Language Model), to select which parts of an entity should be modified. The aim of doing so is to provide guardrails for correct modification, so that words such as "C:\\Windows\\System32" remain untranslated, while other words (e.g., "C:\\Program Files") are modified. This logic aims to prevent words which have a meaning in natural language (e.g., "windows") being inadvertently translated to their foreign-language counterpart (e.g., "die Fenster"). This logic also allows for strings, such as names of files, to be modified into versions containing non-standard-Latin characters, even if the original file name is not a natural-language word suitable for translation - so e.g., "abcdef.bat" could be modified to "äèëóüê.bat", for the purposes of testing the robustness of a ML detection classifier to non-standard inputs.

Furthermore, to ensure that the synthetically-generated data resemble real-life data, in a statistical sense, while preserving the privacy of the restricted target data (e.g., EU data) and avoiding the export of any PII, the disclosed embodiments provide a data distribution validation mechanism, whereby an ML model is used, separately on real data and on synthetic data, to obtain statistics which do not contain PII, such as the distribution of model predictions, e.g., numbers between 0 and 1 indicating a maliciousness score or, e.g., the average of the feature importance scores, or Shapley values (averaged across a large number of client IDs, for privacy), which can in turn be used to select a subset of the synthetic dataset whose statistics resemble those of the real data, to ensure that the synthetic dataset does not sway the analysis or the model retrain too far away from what is expected in the field data.

Thus, the disclosed embodiments allow for building a multi-language corpus in a cost-effective way, by utilizing preexisting entities, thus saving threat analyst time to manually hunt for similar entities in a large number of languages. The disclosed embodiments also solve the problems associated with data export limitations, which reduce a US-based cybersecurity service provider’s ability to build a multi-language corpus directly from multi-cloud field data.

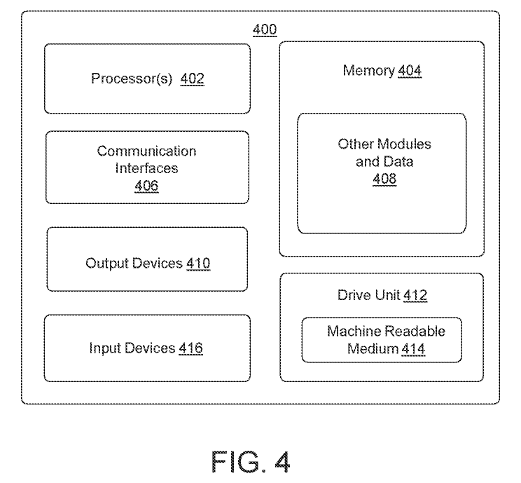

FIG. 4 depicts an example architecture for a computing device 400 that can carry out embodiments of the invention. The computing device 400 can be one or more computing devices, such as a client computing device, a workstation, a personal computer (PC), a laptop computer, a tablet computer, a personal digital assistant (PDA), a cellular phone, a media center, an embedded system, a server or server farm, multiple distributed server farms, a mainframe, or any other type of computing device. As shown in FIG. 4, computing device 400 can include processor(s) 402, memory 404, communication interface(s) 406, output devices 410, input devices 416, and/or a drive unit 412 including a machine readable medium 414.

In various examples, the processor(s) 402 can be a central processing unit (CPU), a graphics processing unit (GPU), or both CPU and GPU, or any other type of processing unit. Each of the one or more processor(s) 402 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 402 may also be responsible for executing drivers and other computer-executable instructions for applications, routines, or processes stored in the memory 404, which can be associated with common types of volatile (RAM) and/or nonvolatile (ROM) memory.

In various examples, the memory 404 can include system memory, which may be volatile (such as RAM), non-volatile (such as ROM, flash memory, etc.) or some combination of the two. Memory 404 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the computing device 400. Any such non-transitory computer-readable media may be part of the computing device 400.

The memory 404 can store data, including computer-executable instructions. The memory 404 can also store any other modules and data 408 that can be utilized by the computing device 400 to perform or enable performing any action taken by the computing device 400 or in connection with one or more user accounts. For example, the modules and data can be a platform, operating system, and/or applications, as well as data utilized by the platform, operating system, and/or applications.

The communication interfaces 406 can link the computing device 400 to other elements through wired or wireless connections. For example, communication interfaces 406 can be wired networking interfaces, such as Ethernet interfaces or other wired data connections, or wireless data interfaces that include transceivers, modems, interfaces, antennas, and/or other components, such as a Wi-Fi interface. The communication interfaces 406 can include one or more modems, receivers, transmitters, antennas, interfaces, error correction units, symbol coders and decoders, processors, chips, application specific integrated circuits (ASICs), programmable circuit (e.g., field programmable gate arrays), software components, firmware components, and/or other components that enable the computing device 400 to send and/or receive data, with the communication interfaces 406.

The output devices 410 can include one or more types of output devices, such as speakers or a display, such as a liquid crystal display. Output devices 410 can also include ports for one or more peripheral devices, such as headphones, peripheral speakers, and/or a peripheral display. In some examples, a display can be a touch-sensitive display screen, which can also act as an input device 416.

The input devices 416 can include one or more types of input devices, such as a microphone, a keyboard or keypad, and/or a touch-sensitive display, such as the touch-sensitive display screen described above.

The drive unit 412 and machine readable medium 414 can store one or more sets of computer-executable instructions, such as software or firmware, that embodies any one or more of the methodologies or functions described herein. The computer-executable instructions can also reside, completely or at least partially, within the processor(s) 402, memory 404, and/or communication interface(s) 406 during execution thereof by the computing device 400. The processor(s) 402 and the memory 404 can also constitute machine readable media 414.

Some or all operations of the methods described above can be performed by execution of computer-readable instructions stored on a computer-readable storage medium, as defined below. The term "computer-readable instructions" as used in the description and claims, include routines, applications, application modules, program modules, programs, components, data structures, and the like. Computer-readable instructions can be implemented on various system configurations, including single processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory ("RAM")) and/or non-volatile memory (such as read-only memory ("ROM''), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and nonvolatile, removable and non-removable media implemented in any process or technology for storage of information such as computer-readable instructions, data structures, program modules, or other data. Computer-readable storage media includes, but is not limited to, phase change memory ("PRAM"), static random-access memory ("SRAM"), dynamic random-access memory ("DRAM"), other types of random-access memory ("RAM"), read-only memory ("ROM"), electrically erasable programmable read-only memory ("EEPROM''), flash memory or other memory technology, compact disk read-only memory ("CD-ROM"), digital versatile disks ("DVD") or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 1-3. Generally, computerreadable instructions include routines, programs, objects, components, data structures, and the like that perform functions or implement abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method, performed by a computing device having at least a memory in which to store executable instructions and a processing unit to read and execute the instructions according to the computer-implemented method, comprising:
selecting from a first dataset accessible in a first cloud computing environment a plurality of labeled entities written in a first language or in a first writing convention for the first language;
translating the plurality of labeled entities written in the first language or in the first writing convention for the first language into a second language or a writing convention other than the first writing convention for the first language;
generating aggregated statistical information for the translated plurality of labeled entities;
generating aggregated statistical information for a plurality of unlabeled entities obtained from a second dataset accessible only in a second cloud computing environment and written in the second language or in the writing convention other than the first writing convention for the first language;
selecting one or more of the translated plurality of labeled entities, based on the aggregated statistical information for the translated plurality of labeled entities and the aggregated statistical information for the plurality of unlabeled entities;
adding the selected one or more of the translated plurality of labeled entities to the first dataset, thereby creating an expanded first dataset;
training a Machine Learning (ML) model with the expanded first dataset; and
deploying the ML model, once trained with the expanded first dataset, in the second cloud computing environment to detect behaviors in entities in events received from client computing devices operating in the second cloud computing environment.

2. The computer-implemented method of claim 1, further comprising receiving user input to select from the first dataset the plurality of labeled entities written in the first language or in the first writing convention for the first language.

3. The computer-implemented method of claim 1, wherein selecting from the first dataset the plurality of labeled entities written in the first language or in the first writing convention for the first language, comprises selecting from the first dataset via a Large Language Model (LLM) or syntax-tree generation algorithm a portion of a labeled entity written in the first language.

4. The computer-implemented method of claim 1, wherein translating the plurality of labeled entities written in the first language or in the first writing convention for the first language into the second language or the writing convention other than the first writing convention for the first language, comprises modifying via a Large Language Model (LLM) the plurality of labeled entities written in the first language or in the first writing convention for the first language to include characters with which the plurality of labeled entities can be written in the second language or in the writing convention other than the first writing convention for the first language.

5. The computer-implemented method of claim 1, wherein generating aggregated statistical information for the translated plurality of labeled entities comprises:
generating, via execution of a Machine Learning (ML) model, statistical information for the translated plurality of labeled entities; and
aggregating the statistical information for the translated plurality of labeled entities to produce the aggregated statistical information for the translated plurality of labeled entities.

6. The computer-implemented method of claim 1, further comprising receiving user input to select the one or more of the plurality of unlabeled entities written in the second language or in the writing convention other than the first writing convention for the first language.

7. The computer-implemented method of claim 1, wherein generating aggregated statistical information for the plurality of unlabeled entities written in the second language or in the writing convention other than the first writing convention for the first language, comprises:
generating, via execution of an ML model, statistical information for the plurality of unlabeled entities; and
aggregating the statistical information for the plurality of unlabeled entities to produce aggregated statistical information for the plurality of unlabeled entities.

8. The computer-implemented method of claim 1, wherein selecting one or more of the translated plurality of labeled entities, based on the aggregated statistical information for the translated plurality of labeled entities and the aggregated statistical information for the plurality of unlabeled entities, comprises selecting one or more of the translated plurality of labeled entities for which the aggregated statistical information is substantially similar to the aggregated statistical information for the selected plurality of unlabeled entities.

9. A computer system, comprising:
a memory to store computer-executable instructions;
one or more processors to read from the memory and execute the instructions, comprising:
selecting from a first dataset accessible in a first cloud computing environment a plurality of labeled entities written in a first language or in a first writing convention for the first language;
translating the plurality of labeled entities written in the first language or in the first writing convention for the first language into a second language or a writing convention other than the first writing convention for the first language;
generating aggregated statistical information for the translated plurality of labeled entities;
generating aggregated statistical information for a plurality of unlabeled entities obtained from a second dataset accessible only in a second cloud computing environment and written in the second language or in the writing convention other than the first writing convention for the first language;
selecting one or more of the translated plurality of labeled entities, based on the aggregated statistical information for the translated plurality of labeled entities and the aggregated statistical information for the plurality of unlabeled entities;
adding the selected one or more of the translated plurality of labeled entities to the first dataset, thereby creating an expanded first dataset;
training a Machine Learning (ML) model with the expanded first dataset; and
deploying the ML model, once trained with the expanded first dataset, in the second cloud computing environment to detect behaviors in entities in events received from client computing devices operating in the second cloud computing environment.

10. The computer system of claim 9, wherein selecting from the first dataset the plurality of labeled entities written in the first language or in the first writing convention for the first language, comprises selecting from the first dataset via a Large Language Model (LLM) or syntax-tree generation algorithm a portion of a labeled entity written in the first language or in the first writing convention for the first language.

11. The computer system of claim 9, wherein translating the plurality of labeled entities written in the first language or in the first writing convention for the first language into the second language or the writing convention other than the first writing convention for the first language, comprises modifying via a Large Language Model (LLM) the plurality of labeled entities written in the first language or in the first writing convention for the first language to include characters with which the plurality of labeled entities can be written in the second language or in the writing convention other than the first writing convention for the first language.

12. The computer system of claim 9, wherein generating aggregated statistical information for the translated plurality of labeled entities comprises:
generating, via execution of a Machine Learning (ML) model, statistical information for the translated plurality of labeled entities; and
aggregating the statistical information for the translated plurality of labeled entities to produce the aggregated statistical information for the translated plurality of labeled entities.

13. The computer system of claim 9, further comprising receiving user input to select the one or more of the plurality of unlabeled entities written in the second language or in the writing convention other than the first writing convention for the first language.

14. The computer system of claim 9, wherein generating aggregated statistical information for the plurality of unlabeled entities written in the second language or in the writing convention other than the first writing convention for the first language, comprises:
generating, via execution of an ML model, statistical information for the plurality of unlabeled entities; and
aggregating the statistical information for the plurality of unlabeled entities to produce aggregated statistical information for the plurality of unlabeled entities.

15. A non-transitory computer-readable medium storing computer-executable instructions that, when executed by one or more processors, cause the one or more processors to execute instructions, comprising:
selecting from a first dataset accessible in a first cloud computing environment a plurality of labeled entities written in a first language or in a first writing convention for the first language;
translating the plurality of labeled entities written in the first language or in the first writing convention for the first language into a second language or a writing convention other than the first writing convention for the first language;
generating aggregated statistical information for the translated plurality of labeled entities;
generating aggregated statistical information for a plurality of unlabeled entities obtained from a second dataset accessible only in a second cloud computing environment and written in the second language or in the writing convention other than the first writing convention for the first language;
selecting one or more of the translated plurality of labeled entities, based on the aggregated statistical information for the translated plurality of labeled entities and the aggregated statistical information for the plurality of unlabeled entities; and
adding the selected one or more of the translated plurality of labeled entities to the first dataset, thereby creating an expanded first dataset;
training a Machine Learning (ML) model with the expanded first dataset; and
deploying the ML model, once trained with the expanded first dataset, in the second cloud computing environment to detect behaviors in entities in events received from client computing devices operating in the second cloud computing environment.

16. The non-transitory computer-readable medium of claim 15, wherein selecting from the first dataset the plurality of labeled entities written in the first language or in the first writing convention for the first language, comprises selecting from the first dataset via an Large Language Model (LLM) or syntax-tree generation algorithm a portion of a labeled entity written in the first language or in the first writing convention for the first language.

17. The non-transitory computer-readable medium of claim 15, wherein translating the plurality of labeled entities written in the first language or in the first writing convention for the first language into the second language or the writing convention other than the first writing convention for the first language, comprises modifying via a Large Language Model (LLM) the plurality of labeled entities written in the first language or in the first writing convention for the first language to include characters with which the plurality of labeled entities can be written in the second language or in the writing convention other than the first writing convention for the first language.

18. The non-transitory computer-readable medium of claim 15, wherein generating aggregated statistical information for the translated plurality of labeled entities comprises:
generating, via execution of a Machine Learning (ML) model, statistical information for the translated plurality of labeled entities; and
aggregating the statistical information for the translated plurality of labeled entities to produce the aggregated statistical information for the translated plurality of labeled entities.

19. The non-transitory computer-readable medium of claim 15, further comprising receiving user input to select the one or more of the plurality of unlabeled entities written in the second language or in the writing convention other than the first writing convention for the first language.

20. The non-transitory computer-readable medium of claim 15, wherein generating aggregated statistical information for the plurality of unlabeled entities written in the second language or in the writing convention other than the first writing convention for the first language, comprises:
generating, via execution of an ML model, statistical information for the plurality of unlabeled entities; and
aggregating the statistical information for the plurality of unlabeled entities to produce aggregated statistical information for the plurality of unlabeled entities.
